(19) United States
(12) Patent Application Publication
(10) Pub. No.: US 2006/0116999 A1
(43) Pub. Date: Jun. 1, 2006

(54) Sequential stepwise query condition building

(75) Inventors: Richard D. Dettinger, Rochester, MN (US); Daniel P. Kolz, Rochester, MN (US); Richard J. Stevens, Rochester, MN (US); Jeffrey W. Tenner, Rochester, MN (US)

Correspondence Address: William J. McGinnis;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/999,487

(22) Filed: Nov. 30, 2004

(51) Int. Cl. G06F 7/00

(52) U.S. Cl. 707/4

(57) ABSTRACT

A method, system and article of manufacture for query building and, more particularly, for building query conditions for queries against data in a database. One embodiment comprises receiving user input for constructing a first query condition of a query. Then, user-selectable elements to display for constructing a second query condition of the query are identified. Which user-selectable elements are identified is dependent on the first query condition. The identified user-selectable elements for constructing the second query condition are displayed. Then, user selection of one or more of the displayed user-selectable elements for constructing the second query condition is received. The first and second query conditions define selection criteria for selection of a specific set of the data from the database. The selection criteria are programmatically modified in response to construction of the second query condition on the basis of one or more predefined modification rules, whereby the specific set of the data is altered.

### CROSS-RELATED APPLICATION

This application is related to the following commonly owned application: U.S. patent application Ser. No. 10/083,075, filed Feb. 26, 2002, entitled “APPLICATION PORTABILITY AND EXTENSIBILITY THROUGH DATABASE SCHEMA AND QUERY ABSTRACTION”, which is hereby incorporated herein in its entirety.

### BACKGROUND OF THE INVENTION

1. Field of the Invention

The present invention generally relates to query building and, more particularly, to building query conditions for queries against data in a database.

2. Description of the Related Art

Databases are computerized information storage and retrieval systems. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, a database management system (DBMS) can be structured to support a variety of different types of operations for a requesting entity (e.g., an application, the operating system or an end user). Such operations can be configured to retrieve, add, modify and delete information being stored and managed by the DBMS. Standard database access methods support these operations using high-level query languages, such as the Structured Query Language (SQL). The term “query” denominates a set of commands that cause execution of operations for processing data from a stored database. For instance, SQL supports four types of query operations, i.e., SELECT, INSERT, UPDATE and DELETE. A SELECT operation retrieves data from a database, an INSERT operation adds new data to a database, an UPDATE operation modifies data in a database and a DELETE operation removes data from a database.

Any requesting entity, including applications, operating systems and, at the highest level, users, can issue queries against data in a database to obtain required information. Queries may be predefined (i.e., hard coded as part of an application) or generated in response to input (e.g., user input). Queries may include both an explicit specification of result fields for which data is to be returned upon execution of the queries, and criteria used for selection of the data. The data selection criteria are generally represented as query conditions that serve to filter the data returned for the result fields upon execution of the query. Accordingly, a query may be thought of as group of filters put together to sift out only the result field data of interest.

For instance, assume a database which contains information about patients in a hospital and information about medical tests which have been performed on the patients. The information about the patients is contained in a database table “Patientinfo” which is linked to a database table “Screenings” that contains the information about the medical tests. Assume further that a given user wants to determine patient identifiers (patient_ID) of all patients of the hospital having the gender “male” and a positive prostate cancer screening. Therefore, the user needs to create a query against the database which specifies the patient identifiers as result field and which includes two query conditions which filter the patient identifiers as required. More specifically, a first query condition must be created which accesses the “Patientinfo” table to determine all males from the patients of the hospital. Furthermore, a second query condition must be created which accesses the “Screenings” table to identify from the determined males only those having a positive prostate cancer screening.

However, one difficulty in creating query conditions for a query against an underlying database is that users generally need some knowledge of the layout of the underlying database. More specifically, in the given example the user must be aware of the nomenclature used in the database tables “Patientinfo” and “Screenings” in order to identify required columns as condition fields for the query conditions. For instance, the user must know whether the gender “Male” is specified in a “Gender” column or in a “Sex” column. Likewise, the user must know whether information about the prostate cancer screenings is contained in the “Screenings” table or in a “Cancer” table. However, if the number of columns in the “Patientinfo” and “Screenings” tables is large and/or the number of different tables is large, identifying the required columns can be a tedious and frustrating process for the user.

Furthermore, there is no feedback for confirming validity of created queries. In other words, the users must ensure that the queries they created are valid. For instance, while a hemoglobin screening can be valid for both gender, i.e., “Males” and “Females”, many medical tests are gender-specific. By way of example, assume that a user searches information about women having had a positive pregnancy test and, therefore, creates the query condition “Pregnancy test=positive” on the “Screenings” table in the above described database environment. Then, the user wants to restrict the query to women by creating a query condition on the “Patientinfo” table that limits the query to individuals having the gender “Female”. Assume now that the user inadvertently creates the condition “Gender=Male”. Thus, the user creates an invalid query having as data selection criteria “Gender=Male” AND “Pregnancy test=positive”. If the user executes the invalid query against the “Patientinfo” and “Screenings” tables, an empty query result is returned. However, the user may not recognize that the query is invalid and, thus, continue working on the basis of an incorrect query result. Even if the user recognizes that the query is invalid, computer resources and user time are wasted, as the user needs to recreate the query and re-execute it against the database tables.

Therefore, there is a need for an efficient technique for creating query conditions for queries against databases.

### SUMMARY OF THE INVENTION

The present invention is generally directed to a method, system and article of manufacture for query building and, more particularly, for building query conditions for queries against data in a database.

One embodiment provides a computer-implemented method of composing a query against data in a database. The method comprises receiving user input for constructing a first query condition of the query. Then, user-selectable elements to display for constructing a second query condition of the query are identified. Which user-selectable elements are identified is dependent on the first query condition. The identified user-selectable elements for constructing the second query condition are displayed. Then, user selection of one or more of the displayed user-selectable elements for constructing the second query condition is received. The first and second query conditions define selection criteria for selection of a specific set of the data from the database. The selection criteria are programmatically modified in response to construction of the second query condition on the basis of one or more predefined modification rules, whereby the specific set of the data is altered.

Another embodiment provides a computer-implemented method of composing an abstract query against data in a database on the basis of a data abstraction model abstractly describing the data in the database. The method comprises displaying first user-selectable elements for constructing a first query condition of the abstract query. Each user-selectable element is displayed for a different node of a logical tree structure hierarchically representing the data abstraction model. Then, user selection of one or more of the first user-selectable elements for constructing the first query condition is received; and nodes from the logical tree structure for constructing a second query condition of the abstract query are identified. Which nodes are identified is dependent on the first query condition. For the identified nodes second user-selectable elements for constructing the second query condition of the abstract query are displayed. Then, user selection of one or more of the second user-selectable elements for constructing the second query condition is received. The first and second query conditions define selection criteria for selection of a specific set of the data from the database. The selection criteria are programmatically modified in response to construction of the second query condition on the basis of one or more predefined modification rules, whereby the specific set of the data is altered.

Still another embodiment provides a computer-implemented method of constructing queries, comprising displaying a first graphical user interface screen containing user-selectable query-building elements for constructing a first query condition of a query. The method further comprises receiving user selections of the user-selectable query-building elements to construct the first query condition. After constructing the first query condition, one or more additional graphical user interface screens are displayed, each containing user-selectable query-building elements for constructing another query condition of the query. The user-selectable query-building elements of each additional graphical user interface screen are determined by accessing a navigation tree defining which user-selectable query-building elements will be displayed on the basis of a user's previous selections of user-selectable query-building elements for the query. After construction of one or more given query conditions, the query is programmatically modified in response to construction of the given query condition on the basis of one or more predefined modification rules.

Still another embodiment provides a computer-readable medium containing a program which, when executed by a processor, performs operations for composing a query against data in a database. The operations comprise receiving user input for constructing a first query condition of the query. Then, user-selectable elements to display for constructing a second query condition of the query are identified. Which user-selectable elements are identified is dependent on the first query condition. The identified user-selectable elements for constructing the second query condition are displayed. Then, user selection of one or more of the displayed user-selectable elements for constructing the second query condition is received. The first and second query conditions define selection criteria for selection of a specific set of the data from the database. The selection criteria is programmatically modified in response to construction of the second query condition on the basis of one or more predefined modification rules, whereby the specific set of the data is altered.

Still another embodiment provides a computer-readable medium containing a program which, when executed by a processor, performs operations for composing an abstract query against data in a database on the basis of a data abstraction model abstractly describing the data in the database. The operations comprise displaying first user-selectable elements for constructing a first query condition of the abstract query. Each user-selectable element is displayed for a different node of a logical tree structure hierarchically representing the data abstraction model. Then, user selection of one or more of the first user-selectable elements for constructing the first query condition is received; and nodes from the logical tree structure for constructing a second query condition of the abstract query are identified. Which nodes are identified is dependent on the first query condition. Then, second user-selectable elements are displayed for the identified nodes for constructing the second query condition of the abstract query; and user selection of one or more of the second user-selectable elements for constructing the second query condition is received. The first and second query conditions define selection criteria for selection of a specific set of the data from the database. The selection criteria is programmatically modified in response to construction of the second query condition on the basis of one or more predefined modification rules, whereby the specific set of the data is altered.

Still another embodiment provides a computer-readable medium containing a program which, when executed by a processor, performs operations for constructing queries. The operations comprise displaying a first graphical user interface screen containing user-selectable query-building elements for constructing a first query condition of a query; and receiving user selections of the user-selectable query-building elements to construct the first query condition. After constructing the first query condition, one or more additional graphical user interface screens are displayed, each containing user-selectable query-building elements for constructing another query condition of the query. The user-selectable query-building elements of each additional graphical user interface screen are determined by accessing a navigation tree defining which user-selectable query-building elements will be displayed on the basis of a user's previous selections of user-selectable query-building elements for the query. After construction of one or more given query conditions, the query is programmatically modified in response to construction of the given query condition on the basis of one or more predefined modification rules.

Still another embodiment provides a system comprising a display device, a navigation structure, one or more modification rules, a user interface and a condition manager. The navigation structure defines predefined navigation paths for users. The one or more modification rules define application of modifications to a query condition on the basis of another query condition. The user interface is configured for composing a query against data in a database. The condition manager is configured to receive user input for constructing a first query condition of the query from the user interface. Then, the condition manager accesses the navigation structure to identify user-selectable elements to display for constructing a second query condition of the query, wherein each navigation path specifies which of a plurality of user-selectable elements to display dependent on the first query condition. The identified user-selectable elements for constructing the second query condition are displayed on the display device. Then, user selection of one or more of the displayed user-selectable elements for constructing the second query condition is received from the user interface, wherein the first and second query conditions define selection criteria for selection of a specific set of the data from the database. The selection criteria are programmatically modified in response to construction of the second query condition on the basis of one or more corresponding modification rules, whereby the specific set of the data is altered.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with the invention;

FIGS. 2-3B are relational views of software components for query building support in one embodiment;

FIGS. 4-5 are flow charts illustrating the operation of a runtime component;

FIG. 6 is a relational view of software components in one embodiment;

FIG. 7 is a flow chart illustrating a method for composing a query in one embodiment; and

FIG. 8 is a relational view of screen shots of a user interface in relation to hierarchical levels in a logical tree structure in one embodiment.

### DETAILED DESCRIPTION OF THE PREFERRED EMBODIMENTS

Introduction

The present invention generally is directed to a system, method and article of manufacture for query building and, more particularly, for building query conditions for queries against data in a database. According to one aspect, a query building framework is provided wherein each query condition that a user constructs for a given query which is under construction may affect a previously constructed query condition of the given query. The query building framework is configured to modify the previously constructed query condition(s) of the given query in response to current selections being made.

More specifically, each query may include a plurality of query conditions defining selection criteria for selection of a specific set of data from a given database. Each of the plurality of query conditions can be created by a user using a suitable query building user interface. One or more of the plurality of query conditions can be created or modified programmatically in response to user selection(s) received from the query building user interface in creation of at least a portion of the plurality of query conditions.

In one embodiment, when a query building session is initiated, a first graphical user interface screen is displayed. The first graphical user interface screen contains user-selectable query-building elements for constructing a first query condition of a given query against the data in the given database. Thus, the user can select one or more of the user-selectable query-building elements to construct the first query condition. After constructing the first query condition, one or more additional graphical user interface screens are displayed. Each of the one or more additional graphical user interface screens contains user-selectable query-building elements for constructing another query condition of the given query. The user-selectable query-building elements of each additional graphical user interface screen are determined by accessing a navigation tree. The navigation tree defines which user-selectable query-building elements will be displayed on the basis of a user's previous selection(s) of user-selectable query-building elements for the given query. Thus, the user can select one or more of the user-selectable query-building elements from the one or more additional graphical user interface screens to construct one or more other query conditions. After construction of a given query condition, the given query is programmatically modified in response to construction of the given query condition on the basis of one or more predefined modification rules. According to one aspect, programmatically modifying the given query includes at least one of: (i) restricting the selection criteria defined by the first and the given query conditions to reduce a specific set of data requested by the given query, (ii) adding an additional query condition to the selection criteria, and (iii) changing the first query condition based on the given query condition.

In one embodiment, the given query is an abstract query and the data in the given database is abstractly described by a data abstraction model. Accordingly, the navigation tree can be defined as a logical tree structure having a plurality of nodes, each representing one of a logical field, a navigational category, and a conditional category of the data abstraction model. Each logical field is mapped to one or more physical entities of the data in the given database. For each logical field a predefined modification rule can be defined to specify a modification of the selection criteria to be performed if a query condition is build on the logical field. Each navigational category defines a category for logically grouping logical fields on the basis of user-defined grouping criteria. Each conditional category defines a category for logically grouping logical fields on the basis of a category condition defining at least one query condition to be applied to the abstract query on the basis of the one or more predefined modification rules. In other words, when the user navigates through a node of the logical tree structure which corresponds to a conditional category, the at least one query condition associated with that conditional category is applied to the abstract query. According to one aspect, the logical tree structure may have a plurality of logical branches, each including a subset of the plurality of nodes

It should be noted that embodiments of the present invention can be explained below, by way of example, with reference to abstract queries which are created on the basis of a corresponding data abstraction model. However, other embodiments can be implemented using other types of queries and database representations, such as SQL or XML queries issued against data in databases having an underlying relational or XML data representation. Accordingly, the present invention is not limited to a particular query environment, including abstract queries and data abstraction models, and various different query environments and implementations are broadly contemplated.

### Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

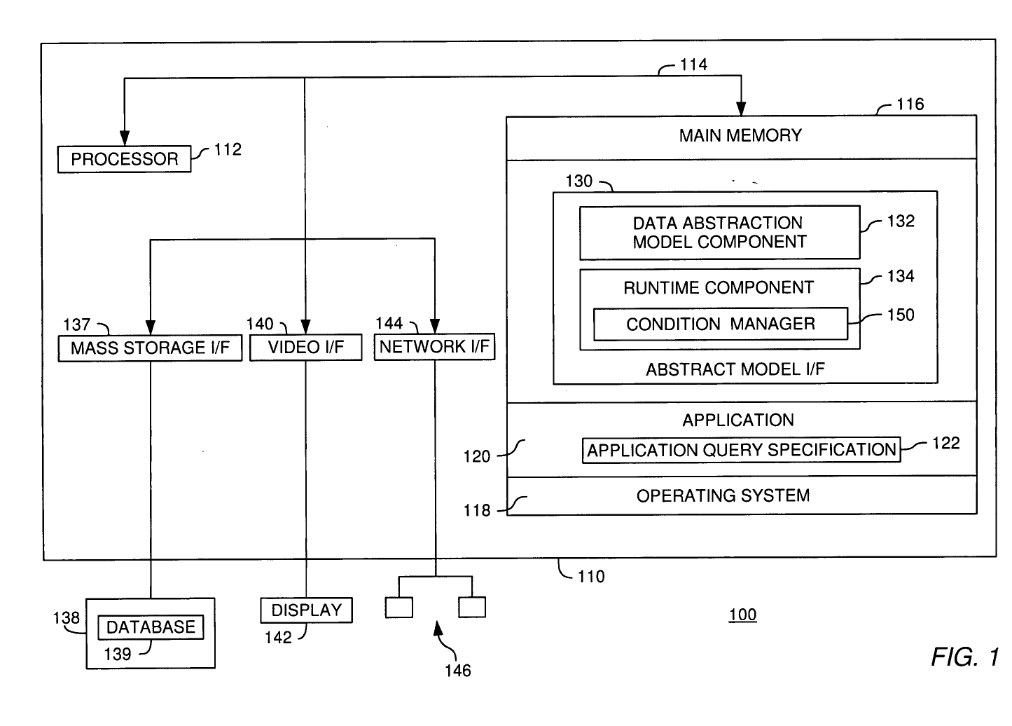

One embodiment of the invention is implemented as a program product for use with a computer system such as, for example, computer system 110 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

Referring now to FIG. 1, a computing environment 100 is shown. In general, the distributed environment 100 includes computer system 110 and a plurality of networked devices 146. The computer system 110 may represent any type of computer, computer system or other programmable electronic device, including a client computer, a server computer, a portable computer, an embedded controller, a PC-based server, a minicomputer, a midrange computer, a mainframe computer, and other computers adapted to support the methods, apparatus, and article of manufacture of the invention. In one embodiment, the computer system 110 is an eServer computer available from International Business Machines of Armonk, N.Y.

Illustratively, the computer system 110 comprises a networked system. However, the computer system 110 may also comprise a standalone device. In any case, it is understood that FIG. 1 is merely one configuration for a computer system. Embodiments of the invention can apply to any comparable configuration, regardless of whether the computer system 110 is a complicated multi-user apparatus, a single-user workstation, or a network appliance that does not have non-volatile storage of its own.

The embodiments of the present invention may also be practiced in distributed computing environments in which tasks are performed by remote processing devices that are linked through a communications network. In a distributed computing environment, program modules may be located in both local and remote memory storage devices. In this regard, the computer system 110 and/or one or more of the networked devices 146 may be thin clients which perform little or no processing.

The computer system 110 could include a number of operators and peripheral systems as shown, for example, by a mass storage interface 137 operably connected to a direct access storage device 138, by a video interface 140 operably connected to a display 142, and by a network interface 144 operably connected to the plurality of networked devices 146. The display 142 may be any video output device for outputting viewable information.

Computer system 110 is shown comprising at least one processor 112, which obtains instructions and data via a bus 114 from a main memory 116. The processor 112 could be any processor adapted to support the methods of the invention. The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer system 110 via bus 114.

The memory 116 is shown configured with an operating system 118. The operating system 118 is the software used for managing the operation of the computer system 110. Examples of the operating system 118 include IBM OS/400®, UNIX, Microsoft Windows®, and the like.

The memory 116 further includes one or more applications 120 and an abstract model interface 130. The applications 120 and the abstract model interface 130 are software products comprising a plurality of instructions that are resident at various times in various memory and storage devices in the computer system 110. When read and executed by one or more processors 112 in the computer system 110, the applications 120 and the abstract model interface 130 cause the computer system 110 to perform the steps necessary to execute steps or elements embodying the various aspects of the invention. The applications 120 (and more generally, any requesting entity, including the operating system 118) are configured to issue queries against a database 139 (shown in storage 138). The database 139 is representative of any collection of data regardless of the particular physical representation of the data. A physical representation of data defines an organizational schema of the data. By way of illustration, the database 139 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data.

The queries issued by the applications 120 are defined according to an application query specification 122 included with each application 120. The queries issued by the applications 120 may be predefined (i.e., hard coded as part of the applications 120) or may be generated in response to input (e.g., user input). In either case, the queries (referred to herein as “abstract queries”) can be composed using logical fields defined by the abstract model interface 130. A logical field defines an abstract view of data whether as an individual data item or a data structure in the form of, for example, a database table. In particular, the logical fields used in the abstract queries are defined by a data abstraction model component 132 of the abstract model interface 130.

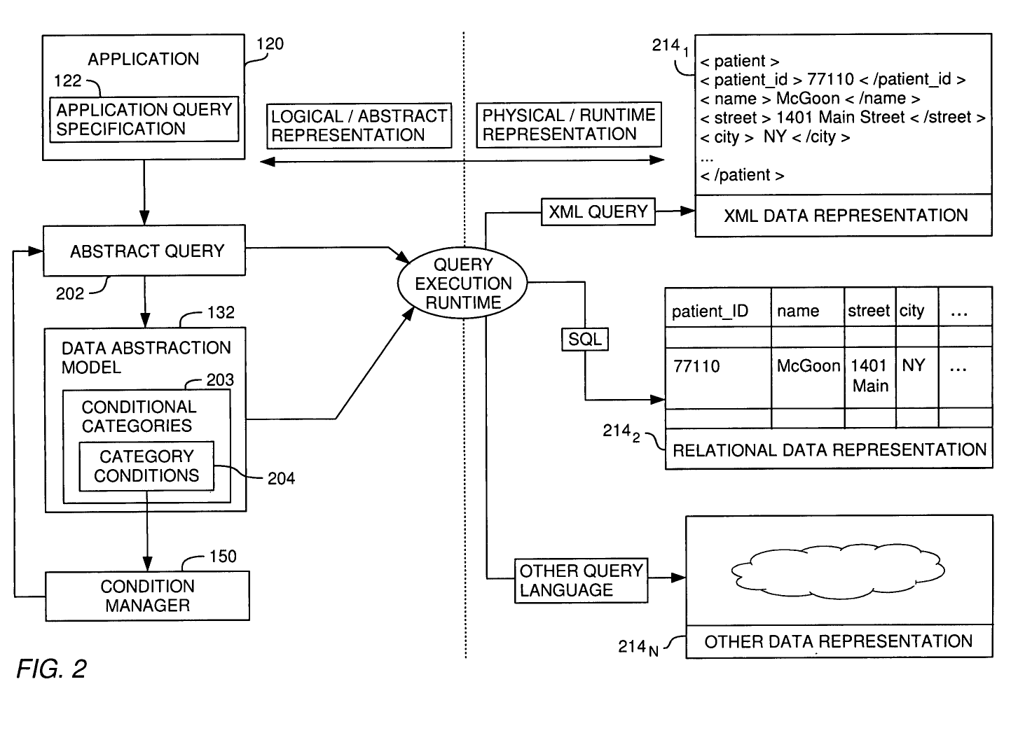

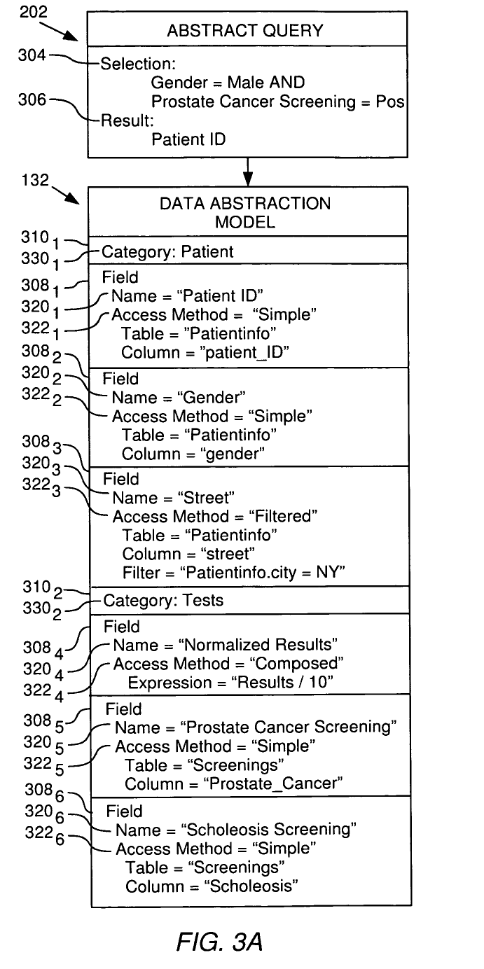

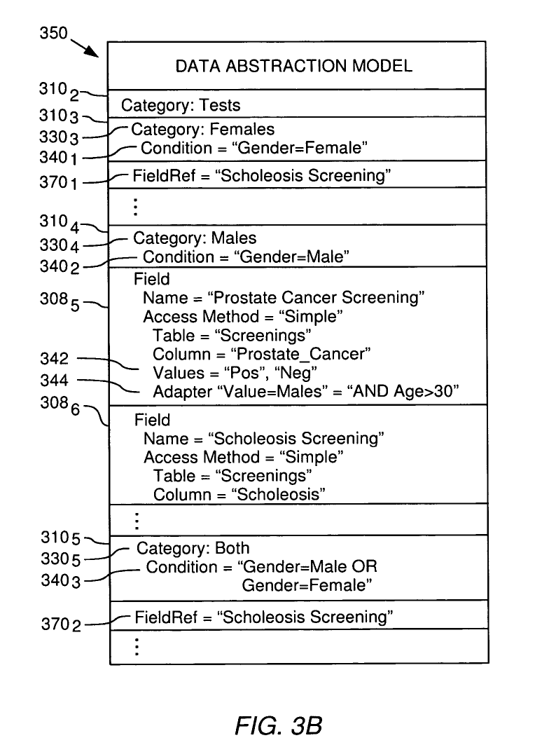

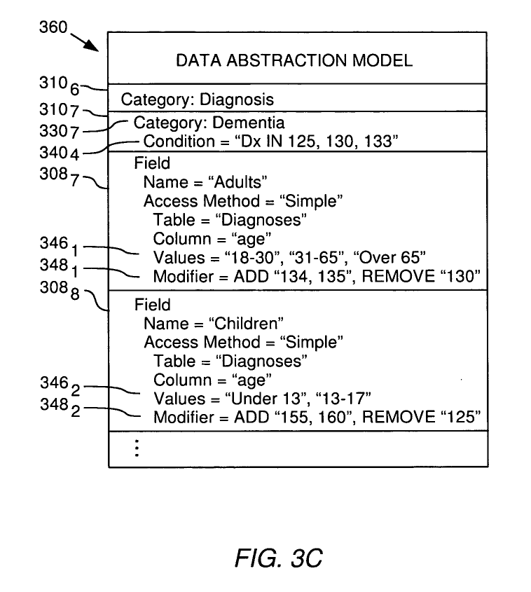

In one embodiment, the data abstraction model component 132 includes one or more conditional categories having associated category conditions which are managed by a condition manager 150. The category conditions describe modifications that are programmatically performed on data selection criteria which define query conditions that serve to filter data returned upon execution of a given abstract query. Operation and interaction of the data abstraction model 132 and the condition manager 150 are further described below with reference to FIGS. 2-3.

Illustratively, the condition manager 150 is shown as part of a runtime component 134. The runtime component 134 transforms the abstract queries into concrete queries having a form consistent with the physical representation of the data contained in the database 139. The concrete queries can be executed by the runtime component 134 against the database 139. Operation of the runtime component 134 is further described below with reference to FIG. 2.

Referring now to FIG. 2, a relational view illustrating interaction of the runtime component 134, the application 120, the data abstraction model 132 and the condition manager 150 at query execution runtime is shown. The data abstraction model 132 is also referred to herein as a “logical representation” because the data abstraction model 132 defines logical fields corresponding to data structures in a database (e.g., database 139), thereby providing an abstract, i.e., a logical view of the data in the database 139. A data structure is a physical arrangement of the data, such as an arrangement in the form of a database table or a column of the database table. More specifically, each logical field defines a logical representation of a particular set of the data in the database 139. In a relational database environment having a multiplicity of database tables, a specific logical representation having specific logical fields can be provided for each database table. In this case, all specific logical representations together constitute the data abstraction model 132. Physical entities of the data are arranged in the database 139 according to a physical representation of the data. A physical entity of data (interchangeably referred to as a physical data entity) is a data item in an underlying physical representation. Accordingly, a physical data entity is the data included in a database table or in a column of the database table, i.e., the data itself. By way of illustration, two physical representations are shown, an XML data representation 214₁ and a relational data representation 214₂. However, the physical representation 214_{N} indicates that any other physical representation, known or unknown, is contemplated. In one embodiment, a different single data abstraction model 132 is provided for each separate physical representation 214, as explained above for the case of a relational database environment. In an alternative embodiment, a single data abstraction model 132 contains field specifications (with associated access methods) for two or more physical representations 214. A field specification is a description of a logical field and generally comprises a mapping rule that maps the logical field to a data structure(s) of a particular physical representation.

Using a logical representation of the data, the application query specification 122 of the application 120 specifies one or more logical fields to compose a resulting query 202. A requesting entity (e.g., the application 120) issues the resulting query 202 as defined by an application query specification of the requesting entity. In one embodiment, the abstract query 202 may include both criteria used for data selection and an explicit specification of result fields to be returned based on the data selection criteria. An example of the data selection criteria and the result field specification of the abstract query 202 is shown in FIG. 3A. Accordingly, the abstract query 202 illustratively includes selection criteria 304 and a result field specification 306.

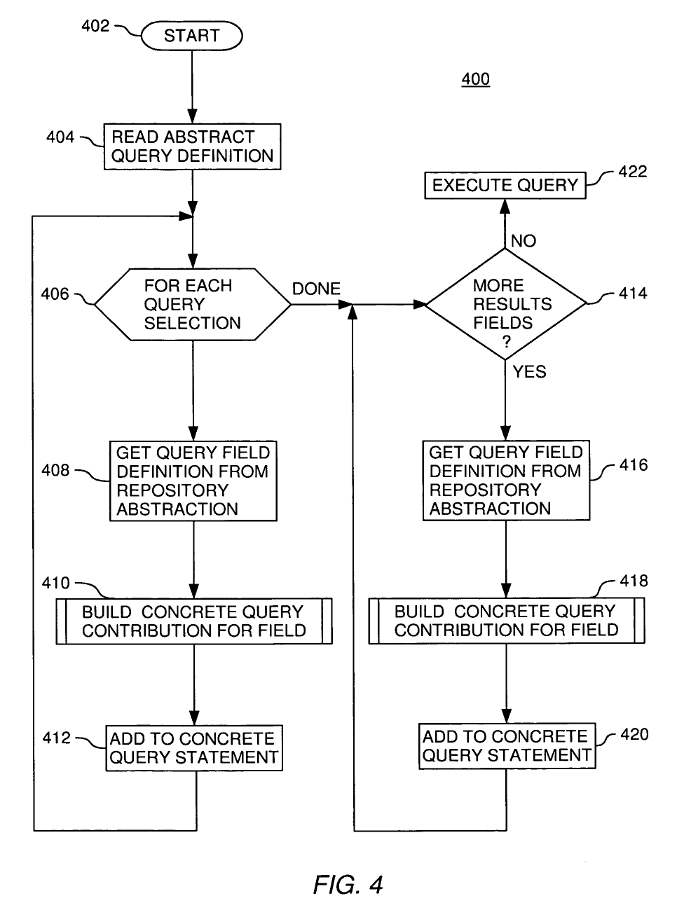

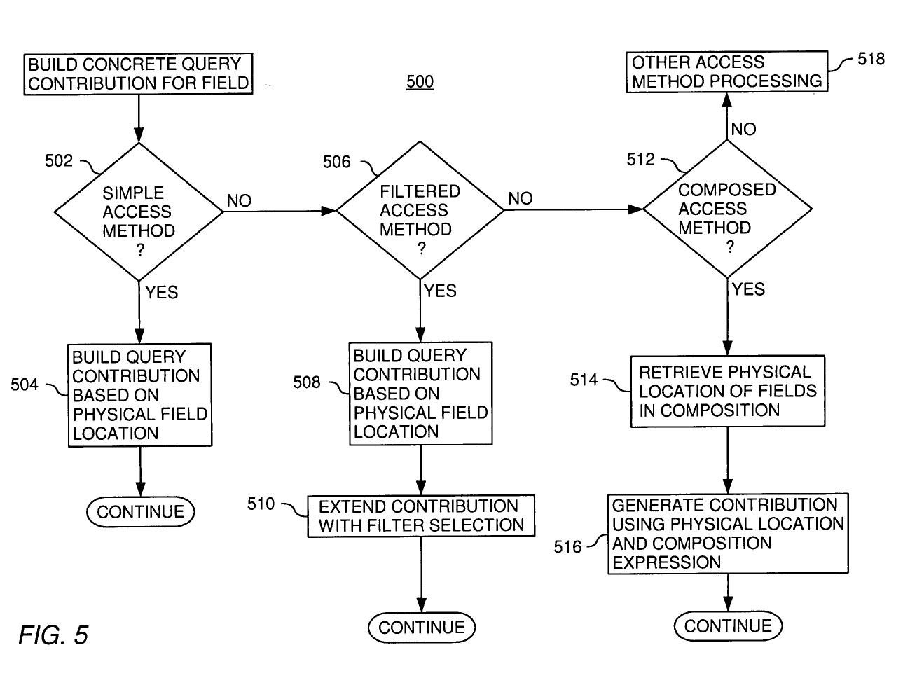

The resulting query 202 is generally referred to herein as an “abstract query” because the query is composed according to abstract (i.e., logical) fields rather than by direct reference to the underlying data structures in the database 139. As a result, abstract queries may be defined that are independent of the particular underlying physical data representation used. For execution, the abstract query is transformed into a concrete query consistent with the underlying physical representation of the data using the data abstraction model 132. The concrete query is executable against the database 139. An exemplary method for transforming the abstract query into a concrete query is described below with reference to FIGS. 4-5.

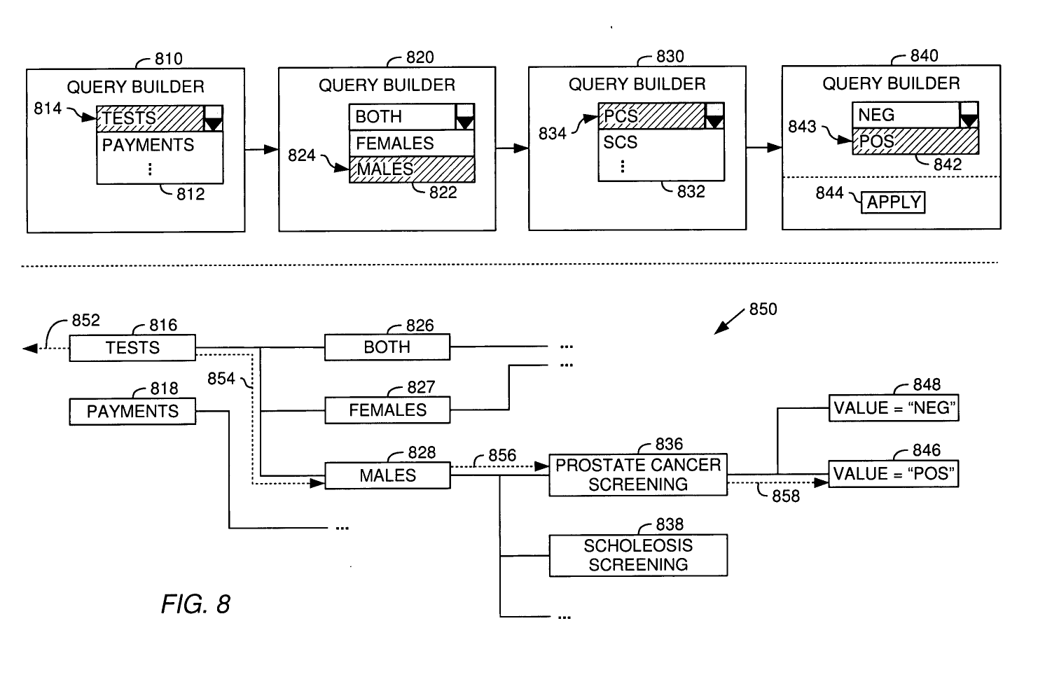

In general, the data abstraction model 132 exposes information as a set of logical fields. According to one aspect, the data abstraction model 132 can be represented as a logical tree structure having a plurality of nodes. An exemplary logical tree structure is shown in FIG. 8. In one embodiment, the logical fields may be used within an abstract query to specify criteria for data selection and specify the form of result data returned from a query operation. The logical fields are defined independently of the underlying physical representation being used in the database 139, thereby allowing abstract queries to be formed that are loosely coupled to the underlying physical representation (i.e., schema).

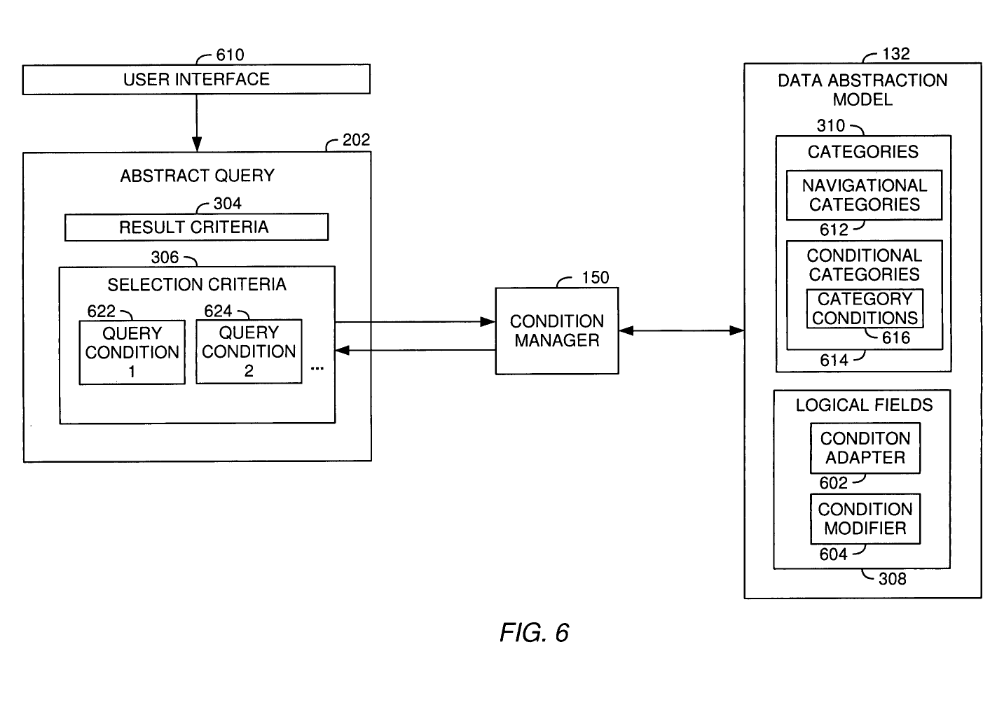

In one embodiment, the data abstraction model 132 includes conditional categories 203 having associated category conditions 204. The conditional categories 203 and the associated category conditions 204 are managed by the condition manager 150. According to one aspect, the condition manager 150 is configured for programmatically creating/modifying the data selection criteria of the abstract query 202 on the basis of the category conditions 204. Operation of an exemplary condition manager 150 is described below with reference to FIGS. 6-8.

Referring now to FIG. 3A, a relational view illustrating interaction of the abstract query 202 and the data abstraction model 132 is shown. In one embodiment, the data abstraction model 132 comprises a plurality of field specifications 308₁, 308₂, 308₃, 308₄, 308₅ and 308₆ (six shown by way of example), collectively referred to as the field specifications 308. Specifically, a field specification is provided for each logical field available for composition of an abstract query. Each field specification may contain one or more attributes. Illustratively, the field specifications 308 include a logical field name attribute 320₁, 320₂, 320₃, 320₄, 320₅, 320₆ (collectively, field name 320) and an associated access method attribute 322₁, 322₂, 322₃, 322₄, 322₅, 322₆ (collectively, access methods 322). Each attribute may have a value. For example, logical field name attribute 320₁ has the value “Patient ID” and access method attribute 322₁ has the value “Simple”. Furthermore, each attribute may include one or more associated abstract properties. Each abstract property describes a characteristic of a data structure and has an associated value. As indicated above, a data structure refers to a part of the underlying physical representation that is defined by one or more physical entities of the data corresponding to the logical field. In particular, an abstract property may represent data location metadata abstractly describing a location of a physical data entity corresponding to the data structure, like a name of a database table or a name of a column in a database table. Illustratively, the access method attribute 322₁ includes data location metadata “Table” and “Column”. Furthermore, data location metadata “Table” has the value “Patientinfo” and data location metadata “Column” has the value “patient_ID”. Accordingly, assuming an underlying relational database schema in the present example, the values of data location metadata “Table” and “Column” point to a table “Patientinfo” having a column “patient_ID”.

In one embodiment, groups (i.e., two or more) of logical fields may be part of categories. Accordingly, the data abstraction model 132 includes a plurality of category specifications 310, and 3102 (two shown by way of example), collectively referred to as the category specifications. In one embodiment, a category specification is provided for each logical grouping of two or more logical fields. For example, logical fields 308₁₋₃ and 308₄₋₆ are part of the category specifications 310₁ and 310₂, respectively. A category specification is also referred to herein simply as a “category”. The categories are distinguished according to a category name, e.g., category names 330₁ and 330₂ (collectively, category name(s) 330). Each category can be associated with a corresponding category condition (e.g., one of category conditions 204 of FIG. 2). Categories having one or more associated category conditions can be used for construction of query conditions and are, therefore, referred to as “conditional” categories hereinafter. Categories without category condition(s) are hereinafter referred to as “navigational” categories, as they are only available for navigation purposes in a corresponding logical tree structure representing the data abstraction model 132. In the present illustration, the logical fields 308₁₋₃ are part of the navigational category “Patient” and logical fields 308₄₋₆ are part of the navigational category “Tests”, both of which are not associated with corresponding category conditions. Conditional categories are explained in more detail below with reference to FIGS. 3B-C.

The access methods 322 generally associate (i.e., map) the logical field names to data in the database (e.g., database 139 of FIG. 1). Any number of access methods is contemplated depending upon the number of different types of logical fields to be supported. In one embodiment, access methods for simple fields, filtered fields and composed fields are provided. The field specifications 308₁, 308₂, 308₅ and 308₆ exemplify simple field access methods 322₁, 322₂, 322₅ and 322₆, respectively. Simple fields are mapped directly to a particular data structure in the underlying physical representation (e.g., a field mapped to a given database table and column). By way of illustration, as described above, the simple field access method 322₁ maps the logical field name 320₁ (“Patient ID”) to a column named “patient_ID” in a table named “Patientinfo”. The field specification 308₃ exemplifies a filtered field access method 322₃. Filtered fields identify an associated data structure and provide filters used to define a particular subset of items within the physical representation. An example is provided in FIG. 3A in which the filtered field access method 322₃ maps the logical field name 320₃ (“Street”) to data in a column named “street” in a table named “Patientinfo” and defines a filter for individuals in the city of “NY”. Another example of a filtered field is a New York ZIP code field that maps to the physical representation of ZIP codes and restricts the data only to those ZIP codes defined for the state of New York. The field specification 308₄ exemplifies a composed field access method 322₄. Composed access methods compute a logical field from one or more data structures using an expression supplied as part of the access method definition. In this way, information which does not exist in the underlying physical data representation may be computed. In the example illustrated in FIG. 3A the composed field access method 322₄ maps the logical field name 320₄ “Normalized Results” to “Results/10”. Another example is a sales tax field that is composed by multiplying a sales price field by a sales tax rate.

It is contemplated that the formats for any given data type (e.g., dates, decimal numbers, etc.) of the underlying data may vary. Accordingly, in one embodiment, the field specifications 308 include a type attribute which reflects the format of the underlying data. However, in another embodiment, the data format of the field specifications 308 is different from the associated underlying physical data, in which case a conversion of the underlying physical data into the format of the logical field is required.

By way of example, the field specifications 308 of the data abstraction model 132 shown in FIG. 3A are representative of logical fields mapped to data represented in the relational data representation 214₂ shown in FIG. 2. However, other instances of the data abstraction model 132 map logical fields to other physical representations, such as XML.

An illustrative abstract query corresponding to the abstract query 202 shown in FIG. 3A is shown in Table I below. By way of illustration, the illustrative abstract query is defined using XML. However, any other language may be used to advantage.

TABLE I
ABSTRACT QUERY EXAMPLE

| 001 | <?xml version=“1.0”?> |
|---|---|
| 002 | <!--Query string representation: (Prostate Cancer |
| | Screening = “Pos”--> |
| 003 | <QueryAbstraction> |

| | |
|---|---|
| 004 | <Selection> |

| | |
|---|---|
| 005 | <Condition internalID=“4”> |

| 006 | <Condition field=“Gender” operator=“EQ” |
|---|---|
| | value=“Male” |

| | |
|---|---|
| 007 | internalID=“1”/> |

| 008 | <Condition field=“Prostate Cancer Screening” |
|---|---|
| | operator=“EQ” |

value=“Pos”

| 009 | internalID=“2” |
|---|---|
| | relOperator=“AND”></Condition> |

| | |
|---|---|
| 010 | </Selection> |
| 011 | <Results> |

| | |
|---|---|
| 012 | <Field name=“Patient ID”/> |

| | |
|---|---|
| 013 | </Results> |

| | |
|---|---|
| 014 | </QueryAbstraction> |

Illustratively, the abstract query shown in Table I includes a selection specification (lines 004-010) containing selection criteria and a result specification (lines 011-013). In one embodiment, a selection criterion (hereinafter also referred to as “search criterion”) consists of a field name (for a logical field), a comparison operator (=, >, <, etc) and a value expression (what is the field being compared to). In one embodiment, result specification is a list of abstract fields that are to be returned as a result of query execution. A result specification in the abstract query may consist of a field name and sort criteria.

An illustrative data abstraction model (DAM) corresponding to the data abstraction model 132 shown in FIG. 3A is shown in Table II below. By way of illustration, the illustrative data abstraction model is defined using XML. However, any other language may be used to advantage.

TABLE II
DATA ABSTRACTION MODEL EXAMPLE

| | |
|---|---|
| 001 | <?xml version=“1.0”?> |
| 002 | <DataAbstraction> |

| | |
|---|---|
| 003 | <Category name=“Patient”> |

| 004 | <Field queryable=“Yes” name=“Patient ID” |
|---|---|
| | displayable=“Yes”> |

| | |
|---|---|
| 005 | <AccessMethod> |

| | |
|---|---|
| 006 | <Simple columnName=“patient_ID” |

tableName=“Patientinfo”></Simple>

| | |
|---|---|
| 007 | </AccessMethod> |

| 008 | </Field> |
|---|---|
| 009 | <Field queryable=“Yes” name=“Gender” |
| | displayable=“Yes”> |

| | |
|---|---|
| 010 | <AccessMethod> |

| | |
|---|---|
| 011 | <Simple columnName=“gender” |

tableName=“Patientinfo”></Simple>

| | |
|---|---|
| 012 | </AccessMethod> |

| 013 | </Field> |
|---|---|
| 014 | <Field queryable=“Yes” name=“Street” |
| | displayable=“Yes”> |

| | |
|---|---|
| 015 | <AccessMethod> |

| 016 | <Filter columnName=“street” |
|---|---|
| | tableName=“Patientinfo”> |
| 017 | </Filter=“Patientinfo.city=NY”> |

| | |
|---|---|
| 018 | </AccessMethod> |

| | |
|---|---|
| 019 | </Field> |

| | |
|---|---|
| 020 | </Category> |
| 021 | <Category name=“Tests”> |

| 022 | <Field queryable=“Yes” name=“Normalized Results” |
|---|---|
| | displayable=“Yes”> |

| | |
|---|---|
| 023 | <Access Method> |

| 024 | <Composed columnName=“results” |
|---|---|
| | tableName=“Bloodtest”> |
| 025 | </Composed Expression=“Results/10”> |

| | |
|---|---|
| 026 | </AccessMethod> |

| 027 | </Field> |
|---|---|
| 028 | <Field queryable=“Yes” name=“Prostate Cancer |
| | Screening” |

| | |
|---|---|
| 029 | displayable=“Yes”> |

| | |
|---|---|
| 030 | <AccessMethod> |

| | |
|---|---|
| 031 | <Simple columnName=“Prostate_Cancer” |

| | |
|---|---|
| 032 | tableName=“Screenings”></Simple> |

| | |
|---|---|
| 033 | </AccessMethod> |

| 034 | </Field> |
|---|---|
| 035 | <Field queryable=“Yes” name=“Scholeosis Screening” |
| | displayable=“Yes”> |

| | |
|---|---|
| 036 | <AccessMethod> |

| | |
|---|---|
| 037 | <Simple columnName=“Scholeosis” |

| | |
|---|---|
| 038 | tableName=“Screenings”></Simple> |

| | |
|---|---|
| 039 | </AccessMethod> |

| | |
|---|---|
| 040 | </Field> |

| | |
|---|---|
| 041 | </Category> |

| | |
|---|---|
| 042 | </DataAbstraction> |

By way of example, note that lines 004-008 correspond to the first field specification 308₁ of the DAM 132 shown in FIG. 3A and lines 009-013 correspond to the second field specification 308₂.

As was noted above, a data abstraction model may include one or more conditional categories. Exemplary data abstraction models including exemplary conditional categories are described below with reference to FIGS. 3B and 3C.

Referring now to FIG. 3B, one embodiment of a data abstraction model 350 containing conditional categories is shown. Illustratively, the data abstraction model 350 is based on the data abstraction model 132 of FIG. 3A and includes exemplary conditional categories 310₃, 310₄ and 310₅. In this example, the exemplary conditional categories 310₃, 310₄ and 310₅ are sub-level nodes with respect to the navigational category 310₂ “Tests” of the data abstraction model 132.

In one embodiment, the conditional categories 310₃, 310₄ and 310₅ are configured for logically grouping logical fields on the basis of associated category conditions 340₁, 340₂ and 340₃ (collectively, category condition 340). Each category condition 340 defines at least one query condition to be applied to data selection criteria (e.g., data selection criteria 304 of FIG. 3A) of a corresponding abstract query (e.g., abstract query 202 of FIG. 3A).

In the illustrated example, the conditional categories 310₃, 310₄ and 310₅ are defined using the logical field 308₂ “Gender” of the data abstraction model 132 of FIG. 3A. However, it should be noted that defining the conditional categories 310₃, 310₄ and 310₅ on the basis of the logical field 308₂ “Gender” is merely exemplary and not limiting of creation of conditional categories. Instead, any possible implementation for creation of conditional categories is broadly contemplated.

In the illustrated example, assume that the logical field 308₂ “Gender” may have three different values: “Female”, “Male”, and “Both”. Accordingly, the conditional category 310₃ with the category name 330₃ “Females” has been created for the value “Female”. For the value “Male”, the conditional category 310₄ with the category name 330₄ “Males” has been created. Furthermore, for the value “Both” the conditional category 310₄ with the category name 330₅ “Both” has been created. Illustratively, the conditional category 310₃ “Females” is associated with a category condition 340₁, which defines a query condition “Gender=Female”. The conditional category 310₄ “Males” is associated with a category condition 340₂, which defines a query condition “Gender=Male”. The conditional category 310₅ “Both” is associated with a category condition 340₃, which defines two query conditions, i.e., “Gender=Male” and “Gender=Female”, which are connected by a Boolean “OR” operator. In one embodiment, selection of one of the conditional categories 310₃, 310₄ and 310₅ or a logical field included therein for construction of a query condition causes construction of a query condition on the basis of the corresponding associated category condition 340, as explained in more detail below with reference to FIG. 8.

It should be noted that in particular embodiments category conditions can be parameterized. For instance, a given conditional category “ZIP code” which arranges underlying categories and logical fields on the basis of zip codes may require user specification of a zip code as input to a corresponding category condition. More specifically, the category condition can be defined as being “ZIP code=ABCDE”, wherein “ABCDE” is a value provided by the user. By way of example, assume that the conditional category 3104 “Males” includes a parameterized zip code conditional category which is used to provide information with respect to individuals of the gender “Male” for different areas based on a user-selectable zip code.

Furthermore, it should be noted that a given field specification may be available for selection in more than one category. By way of example, the “Males” category 310₄ includes the field specifications 308₅ and 308₆ of the navigational category 310₂ “Tests” of the data abstraction model 132 of FIG. 3A. However, including the field specifications 308₅ and 308₆ with the conditional category 310₄ may require a duplication of these field specifications. In order to avoid duplication of field specifications, references, i.e., pointers, to the field specifications can be used. As an example, instead of duplicating for example the logical field 308₆ “Scholeosis Screening” from the navigational category 310₂ “Tests” to the conditional category 310₄ “Males” as shown, a pointer to this logical field can be included with the conditional category 310₄. For instance, a “FieldRef” pointer to the “Scholeosis Screening” field of the navigational category 310₂ “Tests” (i.e., FieldRef=“Scholeosis Screening”) can be used in the conditional category 310₄ “Males” instead of the field specification 308₆. Furthermore, if a given logical field is required in more than one conditional category, the given logical field can be included with a selected conditional category and “FieldRef” pointers to this given logical field are included with the remaining conditional categories. By way of example, the conditional category 310₃ “Females” includes a “FieldRef” pointer 370₁ and the conditional category 310₅ “Both” includes a “FieldRef” pointer 370₂. Both “FieldRef” pointers 370₁ and 370₂ point to the logical field 308₆ “Scholeosis Screening” of the conditional category 310₄ “Males”.

In the illustrated example, the field specification 308₅ of the logical field “Prostate Cancer Screening” is shown having a value attribute 342 and an adapter attribute 344. The value attribute 342 indicates possible values for the logical field “Prostate Cancer Screening”, i.e., “Pos” for positive and “Neg” for negative screening results. The adapter attribute 344 defines a condition adapter which is applied to the data selection criteria of the corresponding abstract query if a specific query condition of the abstract query is built on the logical field “Prostate Cancer Screening”.

Illustratively, the condition adapter includes a condition under which the condition adapter is applied to the data selection criteria (“Value=Males”). Accordingly, the illustrated condition adapter is only applied to the data selection criteria if the conditional category 310₄ “Males” is selected and a query condition is constructed on the “Prostate Cancer Screening” field. The condition adapter further includes an adapter condition with a Boolean operator used for adding the adapter condition to the data selection criteria of the abstract query. Illustratively, the adapter condition is “Age>30” and the Boolean operator is “AND”. More specifically, a prostate cancer screening is generally only performed for individuals of the gender “Male” having an age greater than 30 years. Thus, the data selection criteria can be adapted accordingly to reduce a set of data in a database which is queried by the corresponding abstract query, whereby query processing is accelerated. In other words, if a query condition is built on the logical field “Prostate Cancer Screening” after selection of the conditional category 310₄ “Males”, the adapter condition “Age>30” is applied to the data selection criteria in order to restrict the corresponding abstract query. An exemplary process for composing an abstract query using the data abstraction model 350 is described below with reference to FIG. 8.

An illustrative data abstraction model corresponding to the data abstraction model 350 shown in FIG. 3B is shown in Table III below. By way of illustration, the illustrative data abstraction model is defined using XML. However, any other language may be used to advantage. Furthermore, it should be noted that the illustrative data abstraction model of Table III represents a simplified example of a data abstraction model having conditional categories, whereby only relevant elements and attributes are shown. A more detailed representation as shown in Table II above has been omitted for brevity.

TABLE III
DATA ABSTRACTION MODEL EXAMPLE

| | |
|---|---|
| 001 | <?xml version=“1.0”?> |
| 002 | <DataAbstraction> |

| | |
|---|---|
| 003 | <Category Name=“Test”> |

| | |
|---|---|
| 004 | <Category Name=“Females”> |

| | |
|---|---|
| 005 | <FieldRef Field=“Scholeosis Screening” /> |
| 006 | ... |

| | |
|---|---|
| 007 | </Category> |
| 008 | <Category Name=“Males”> |

| | |
|---|---|
| 009 | <Condition condition=“gender=Male” /> |
| 010 | <Field name=“Prostate Cancer Screening”> |

| | |
|---|---|
| 011 | <Values> |

| | |
|---|---|
| 012 | <Value>Pos</Value> |
| 013 | <Value>Neg</Value> |

| | |
|---|---|
| 014 | </Values> |
| 015 | <Adapter> |

| | |
|---|---|
| 016 | <Category value=“Males”> |

| | |
|---|---|
| 017 | <Add LogicalOperator=“And” |

| | |
|---|---|
| 018 | Condition=“age > 30”/> |

| | |
|---|---|
| 019 | </Category> |

| | |
|---|---|
| 020 | </Adapter> |

| | |
|---|---|
| 021 | </Field> |
| 022 | <Field name=“Scholeosis Screening”> |

| | |
|---|---|
| 023 | ... |

| | |
|---|---|
| 024 | </Field> |

| | |
|---|---|
| 025 | </Category> |
| 026 | <Category Name=“Both”> |

| | |
|---|---|
| 027 | <FieldRef Field=“Scholeosis Screening” /> |
| 028 | ... |

| | |
|---|---|
| 029 | </Category> |

| | |
|---|---|
| 030 | </Category> |

| | |
|---|---|
| 031 | </DataAbstraction> |

Note that lines 004-007 correspond to the conditional category 310₃ “Females” of the DAM 350 shown in FIG. 3B, lines 008-025 correspond to the conditional category 310₄ “Males” and lines 026-030 correspond to the conditional category 310₅ “Both”. Furthermore, note that lines 011-014 correspond to the value attribute 342 and that lines 015-020 correspond to the adapter attribute 344 of the augmented field specification 308₅.

Referring now to FIG. 3C, one embodiment of a data abstraction model 360 containing an exemplary conditional category 310₇ “Dementia” is shown. The data abstraction model 360 illustrates exemplary field specifications (i.e., field specifications 308₇ and 308₈) having modifier attributes (i.e., modifier attributes 348₁ and 348₂). The modifier attributes are configured to change definitions of query conditions included with corresponding data selection criteria. Illustratively, the exemplary conditional category 310₇ “Dementia” is a sub-level node of a navigational category 3106 “Diagnosis”.

In the illustrated example, the conditional category 310₇ “Dementia” is associated with a category condition 340₄ which defines a query condition “Dx IN 125, 130, 133”. In this query condition, “Dx” is a short annotation for “diagnosis code” and “IN” is an SQL operator for specifying a set of data. In other words, the query condition defines diagnosis codes for “Dementia” which are within a group defined by numbers “125”, “130” and “133”. Furthermore, the “Dementia” category 3107 includes exemplary field specifications 308₇ of a logical field “Adults” and 308₈ of a logical field “Children”. The field specification 308₇ of the logical field “Adults” illustratively includes a value attribute 346₁ and a modifier attribute 348₁. The field specification 308₈ of the logical field “Children” illustratively includes a value attribute 346₂ and a modifier attribute 348₂. For brevity, only the field specification 308₇ is described in more detail in the following, as the field specification 308₈ is similar.

The value attribute 346₁ indicates possible values for the logical field “Adults”. By way of example, the possible values are represented as value ranges specifying different age groups of adults, i.e., “18-30” for young adults, “31-65” for mature adults, and “Over 65” for seniors. The modifier attribute 348₁ defines a condition modifier which is applied to data selection criteria (e.g., selection criteria 304 of FIG. 3A) of a corresponding abstract query (e.g., abstract query 202 of FIG. 3A) if the logical field “Adults” is selected in construction of the data selection criteria. The condition modifier specifies a change of the definition of a given query condition included with the data selection criteria such that the given query condition becomes specific for “Adults”. For instance, assume that the given query condition is initially defined to identify Dx codes for individuals being subject to Dementia from a corresponding database table, where children and adults are characterized by completely different codes. Assume further that, using this query condition, Dx codes for children and adults can be retrieved from the corresponding database table. In this case, the condition modifier can be configured to change the definition of the given query condition such that the given query condition is no longer valid for children and, thus, becomes valid only for adults. For instance, the condition modifier may cause a change of the definition of the given query condition to restrict identification of Dx codes to such codes which are specific to adults.

In one embodiment, the user may select the logical field “Adults” and further select one of the age groups “18-30”, “31-65”, and “Over 65” to specify whether information related to young adults, mature adults or seniors should be retrieved. For instance, if the user selects the logical field “Adults” and the age group of mature adults, a query condition “Age=31-65” can be created.

In another embodiment, the logical field “Adults” can be selected without explicitly specifying one of the predefined age groups. In this case, it is assumed that the user is implicitly requesting information for individuals having an age included within any one of the value ranges “18-30”, “31-65”, and “Over 65”. Accordingly, a query condition such as “Age >=18” (or “Age=18-30 OR Age=31-65 OR Age=Over 65”) would be created. However, instead of simply creating and adding this query condition to the data selection criteria (as described above with reference to condition adapters in FIG. 3B), the query condition “Dx IN 125, 130, 133” of the category condition 3404 is modified in one embodiment to be specific to “Adults”. More specifically, the query condition “Dx IN 125, 130, 133” of the category condition 340₄ is modified according to the condition modifier to change the list of Dx codes to be specific to adults if the logical field “Adults” is selected without specifying one of the predefined age groups. In other words, on the basis of the condition modifier, the values “134” and “135” which are specific to adults are added to the list of Dx codes (ADD “134, 135”) and the value “130” which is specific to children is removed from the list (REMOVE “130”). Accordingly, the query condition “Dx IN 125, 130, 133” of the category condition 340₄ is modified to “Dx IN 125, 133, 134, 135”.

An illustrative data abstraction model corresponding to the data abstraction model 360 shown in FIG. 3C is shown in Table IV below. By way of illustration, the illustrative data abstraction model is defined using XML. However, any other language may be used to advantage. Furthermore, it should be noted that the illustrative data abstraction model of Table IV represents a simplified example of a data abstraction model having conditional categories, whereby only relevant elements and attributes are shown. A more detailed representation as shown in Table II above has been omitted for brevity.

TABLE IV
DATA ABSTRACTION MODEL EXAMPLE

| | |
|---|---|
| 001 | <?xml version=“1.0”?> |
| 002 | <DataAbstraction> |

| | |
|---|---|
| 003 | <Category Name=“Diagnosis”> |

| | |
|---|---|
| 004 | <Category Name=“Dementia”> |

| | |
|---|---|
| 005 | <Condition condition=“Dx IN 125, 130, 133” /> |
| 006 | <Field name=“Adults”> |

| | |
|---|---|
| 007 | <Values> |

| | |
|---|---|
| 008 | <Value val=“18-30”/> |
| 009 | <Value val=“31-65”/> |
| 010 | <Value val=“Over 65”/> |

| | |
|---|---|
| 011 | </Values> |
| 012 | <Modifier> |

| | |
|---|---|
| 013 | <Category value=“Dementia”> |

| | |
|---|---|
| 014 | <Values Add=“134, 135” |

| | |
|---|---|
| 015 | Remove=“130”/> |

| | |
|---|---|
| 016 | </Category> |

| | |
|---|---|
| 017 | </Modifier> |

| | |
|---|---|
| 018 | </Field> |
| 019 | <Field name=“Children”> |

| | |
|---|---|
| 020 | <Values> |

| | |
|---|---|
| 021 | <Value val=“Under 13”/> |
| 022 | <Value val=“13-17”/> |

| | |
|---|---|
| 023 | </Values> |
| 024 | <Modifier> |

| | |
|---|---|
| 025 | <Category value=“Dementia”> |

| | |
|---|---|
| 026 | <Values Add=“155, 160” |

| | |
|---|---|
| 027 | Remove=“125”/> |

| | |
|---|---|
| 028 | </Category> |

| | |
|---|---|
| 029 | </Modifier> |

| | |
|---|---|
| 030 | </Field> |

| | |
|---|---|
| 031 | </Category> |

| | |
|---|---|
| 032 | </Category> |

| | |
|---|---|
| 033 | </DataAbstraction> |

Note that lines 004-031 correspond to the conditional category 3107 “Dementia” of the DAM 360 shown in FIG. 3C. Furthermore, note that lines 007-011 correspond to the value attribute 346₁ and that lines 012-017 correspond to the modifier attribute 348₁ of the field specification 308₇.

It should be noted that a separate condition modifier can be defined for each value or value range of a corresponding logical field. For instance, assume that in the example described above with reference to FIG. 3C the list of Dx codes needs to be different for young children, i.e., children having an age of less than 13 years, and teenagers, i.e., children who are 13 to 17 years old. In this case, the field specification 308₈ can be defined to have a different condition modifier for each value or value range defined in the value attribute 3462.

An illustrative logical field specification having different condition modifiers for each possible value range of the logical field “Children” is shown in Table V below. The illustrative logical field specification is defined on the basis of the logical field specification defined in lines 019-030 in Table IV. By way of illustration, the illustrative logical field specification is defined using XML. However, any other language may be used to advantage. Furthermore, it should be noted that the illustrative logical field specification of Table V represents a simplified example, whereby only relevant elements and attributes of the logical field specification are shown.

TABLE V
LOGICAL FIELD SPECIFICATION EXAMPLE

| | |
|---|---|
| 001 | <Field name=“Children”> |

| | |
|---|---|
| 002 | <Values> |

| | |
|---|---|
| 003 | <Value val=“Under 13”> |

| | |
|---|---|
| 004 | <Modifier> |

| | |
|---|---|
| 005 | <Category value=“Dementia”> |

| | |
|---|---|
| 006 | <Values Add=“160”/> |

| | |
|---|---|
| 007 | </Category> |

| | |
|---|---|
| 008 | </Modifier> |

| | |
|---|---|
| 009 | </Value> |
| 010 | <Value val=“ 13-17”> |

| | |
|---|---|
| 011 | <Modifier> |

| | |
|---|---|
| 012 | <Category value=“Dementia”> |

| | |
|---|---|
| 013 | <Values Add=“155”/> |

| | |
|---|---|
| 014 | </Category> |

| | |
|---|---|
| 015 | </Modifier> |

| | |
|---|---|
| 016 | </Value> |

| | |
|---|---|
| 017 | </Values> |
| 018 | <Modifier> |

| | |
|---|---|
| 019 | <Category value=“Dementia”> |

| | |
|---|---|
| 020 | <Values Remove=“125”/> |

| | |
|---|---|
| 021 | </Category> |

| | |
|---|---|
| 022 | </Modifier> |

| | |
|---|---|
| 023 | </Field> |

Note that the condition modifier defined in lines 024-029 corresponds to the three condition modifiers defined in lines 004-008, 011-015 and 018-022 of Table V. Specifically, the condition modifier in lines 004-008 is configured to modify the data selection criteria to be specific to young children (“Under 13”, line 003). The condition modifier in lines 011-015 is configured to modify the data selection criteria to be specific to teenagers (“13-17”, line 010). Finally, the condition modifier in lines 018-022 is configured to modify the data selection criteria to be specific to any children.

As was noted above, an abstract query can be transformed into a concrete query for query execution. An exemplary method for transforming an abstract query into concrete query is described below with reference to FIGS. 4-5.

Referring now to FIG. 4, an illustrative runtime method 400 exemplifying one embodiment of the operation of the runtime component 134 of FIG. 1 is shown. The method 400 is entered at step 402 when the runtime component 134 receives as input an abstract query (such as the abstract query shown in Table I). At step 404, the runtime component 134 reads and parses the abstract query and locates individual selection criteria and desired result fields. At step 406, the runtime component 134 enters a loop (comprising steps 406, 408, 410 and 412) for processing each query selection criteria statement present in the abstract query, thereby building a data selection portion of a concrete query. In one embodiment, a selection criterion consists of a field name (for a logical field), a comparison operator (=, >, <, etc) and a value expression (what is the field being compared to). At step 408, the runtime component 134 uses the field name from a selection criterion of the abstract query to look up the definition of the field in the data abstraction model 132. As noted above, the field definition includes a definition of the access method used to access the data structure associated with the field. The runtime component 134 then builds (step 410) a concrete query contribution for the logical field being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the database 139 shown in FIG. 1. The concrete query contribution generated for the current field is then added to a concrete query statement. The method 400 then returns to step 406 to begin processing for the next field of the abstract query. Accordingly, the process entered at step 406 is iterated for each data selection field in the abstract query, thereby contributing additional content to the eventual query to be performed.

After building the data selection portion of the concrete query, the runtime component 134 identifies the information to be returned as a result of query execution. As described above, in one embodiment, the abstract query defines a list of result fields, i.e., a list of logical fields that are to be returned as a result of query execution, referred to herein as a result specification. A result specification in the abstract query may consist of a field name and sort criteria. Accordingly, the method 400 enters a loop at step 414 (defined by steps 414, 416, 418 and 420) to add result field definitions to the concrete query being generated. At step 416, the runtime component 134 looks up a result field name (from the result specification of the abstract query) in the data abstraction model 132 and then retrieves a result field definition from the data abstraction model 132 to identify the physical location of data to be returned for the current logical result field. The runtime component 134 then builds (at step 418) a concrete query contribution (of the concrete query that identifies physical location of data to be returned) for the logical result field. At step 420, the concrete query contribution is then added to the concrete query statement. Once each of the result specifications in the abstract query has been processed, the concrete query is executed at step 422.

One embodiment of a method 500 for building a concrete query contribution for a logical field according to steps 410 and 418 is described with reference to FIG. 5. At step 502, the method 500 queries whether the access method associated with the current logical field is a simple access method. If so, the concrete query contribution is built (step 504) based on physical data location information and processing then continues according to method 400 described above. Otherwise, processing continues to step 506 to query whether the access method associated with the current logical field is a filtered access method. If so, the concrete query contribution is built (step 508) based on physical data location information for a given data structure(s). At step 510, the concrete query contribution is extended with additional logic (filter selection) used to subset data associated with the given data structure(s). Processing then continues according to method 400 described above.

If the access method is not a filtered access method, processing proceeds from step 506 to step 512 where the method 500 queries whether the access method is a composed access method. If the access method is a composed access method, the physical data location for each sub-field reference in the composed field expression is located and retrieved at step 514. At step 516, the physical field location information of the composed field expression is substituted for the logical field references of the composed field expression, whereby the concrete query contribution is generated. Processing then continues according to method 400 described above.

If the access method is not a composed access method, processing proceeds from step 512 to step 518. Step 518 is representative of any other access method types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

As was noted above, a data abstraction model may include conditional categories having associated category conditions which are managed by a condition manager. In one embodiment, the condition manager is further configured to manage modifications to data selection criteria of a given query on the basis of the category conditions. Operation of an exemplary condition manager is described below with reference to FIG. 6.

Referring now to FIG. 6, a relational view of components implementing one aspect of the invention is illustrated. The components illustratively include the data abstraction model 132, the abstract query 202 and the condition manager 150 of FIG. 2. The components further include a user interface 610.

Illustratively, the data abstraction model 132 includes a plurality of logical fields 308. Each of the logical fields 308 can be associated with one or more condition adapters 602 (e.g., condition adapter 344 of FIG. 3B) and/or one or more condition modifiers 604 (e.g., condition modifiers 348₁ and 348₂ of FIG. 3C). The data abstraction model 132 further includes a plurality of categories 310, each defining a category of logical fields. In other words, at least a portion of the logical fields 308 is logically grouped in the categories 310. By way of example, the categories 310 include one or more navigational categories 612 and one or more conditional categories 614 (e.g., conditional categories 203 of FIG. 2) having associated category conditions 616 (e.g., category conditions 204 of FIG. 2).

The abstract query 202 is defined on the basis of the data abstraction model 132. More specifically, a user can use the user interface 610 to select one or more of the logical fields 308 as result criteria 304. In other words, the selected logical fields define the result fields of the abstract query 202 for which data is returned based on data selection criteria 306 after execution of the abstract query 202 against a corresponding database. The user can further use the user interface 610 to specify data selection criteria 306, which are used to filter the data which is obtained for the result fields. Illustratively, the data selection criteria 306 include a first query condition 622 “QUERY CONDITION 1” and a second query condition 624 “QUERY CONDITION 2”. Creation of the first and second query conditions is managed by the condition manager 150, as explained in more detail below.

In one embodiment, a given data processing system (e.g., computer system 110 of FIG. 1) initiates a query building session in response to user input (e.g., logon input) received from the user interface 610. In response to further user input, the first query condition 622 of the abstract query 202 is constructed. Generally, the further user input may either be explicit selections of fields and values or may be a selection of one of the conditional categories 614 having an associated category condition, i.e., one of the category conditions 616. In the former situation, the user may, for instance, select a logical field “Patient ID” from the logical fields 308 (e.g., logical field specification 308₁ of FIG. 3A) and input a value “25” to create “Patient ID=25” as first query condition. In the latter situation, the condition manager 150 accesses the data abstraction model 132 upon receipt of the further user input in order to determine, from the associated category condition, a query condition which is, then, included with the data selection criteria 306 for construction of the first query condition 622.

The second query condition 624 is constructed in response to additional user input received from the user interface 610. Upon receipt of the additional user input, the condition manager 150 accesses the data abstraction model 132 to identify a condition adapter and/or modifier which specifies a modification of the data selection criteria 306. Thus, the condition manager 150 can modify the data selection criteria 306 in response to the receipt of the additional user input on the basis of the identified condition adapter and/or modifier.

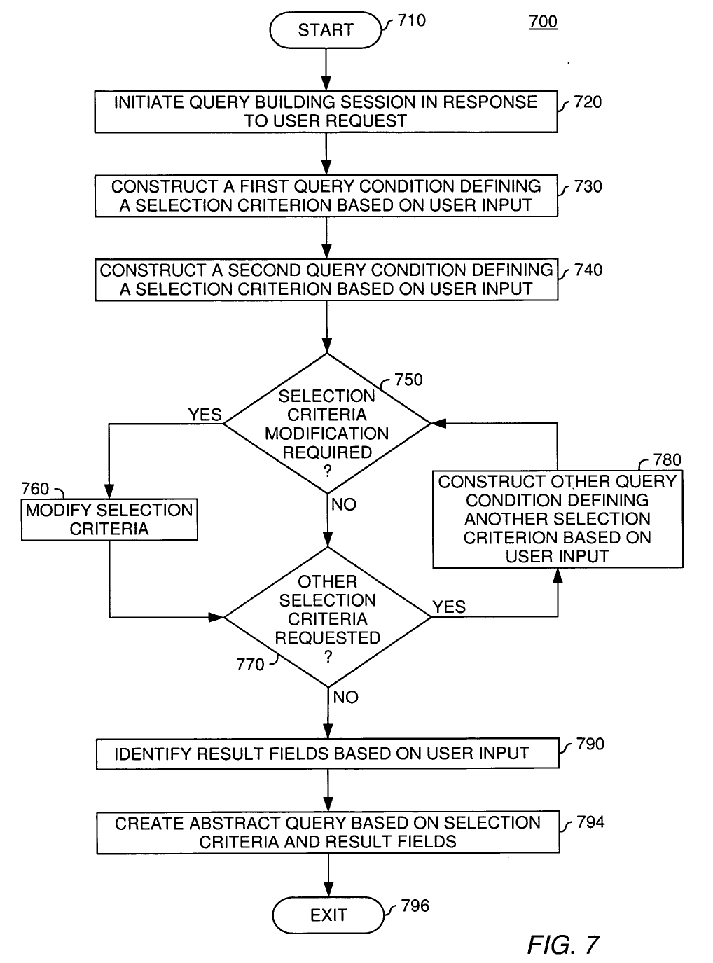

In one embodiment, the condition manager 150 is not invoked until the user completes all the selections involved in building the data selection criteria 306 and then makes an explicit request to construct corresponding query logic. In other words, multiple user selections for the composition of a portion of the abstract query 202 may be received and cached before the condition manager 150 is invoked to construct the various query conditions 622 and 624. This approach may facilitate allowing a user to navigate backwards and undo previous selections; a process which would be complicated once the query conditions were built and integrated into a query statement. An exemplary method of composing an abstract query against data in a database is described below with reference to FIG. 7.

Referring now to FIG. 7, an exemplary method 700 for composing a query (e.g., abstract query 202 of FIG. 2) against data in a database (e.g., database 139 of FIG. 1) is illustrated. In one embodiment, at least a portion of method 700 is performed using a user interface (e.g., user interface 610 of FIG. 6), and a condition manager (e.g., condition manager 150 of FIG. 2). Method 700 starts at step 710.

At step 720, a query building session is initiated in response to a user request. At step 730, a first query condition (e.g., “Gender=Male” in line 006 of Table I) is constructed. At step 740 a second query condition (e.g., “Prostate Cancer Screening=Pos” in line 008 of Table I) is constructed. The first and second query conditions define data selection criteria (e.g., data selection criteria 306 of FIG. 6) of the query.

At step 750, it is determined whether a modification of the data selection criteria is required in response to construction of the second query condition. If a modification is required, the modification is performed at step 760. Processing then continues at step 770. If no modification is required, it is determined at step 770 whether construction of another query condition for the data selection criteria is requested. If so, the other query condition is constructed and included with the data selection criteria at step 780. Processing then returns to step 750. If construction of another query condition is not requested, processing continues at step 790.

At step 790, result fields for construction of a result field specification (e.g., result criteria 304 of FIG. 6) are identified on the basis of user input. At step 794, the query is constructed using the created data selection criteria and result field specification. Method 700 then exits at step 796.

As was noted above, a data abstraction model can be represented as a logical tree structure. In this case, a suitable user interface (e.g., user interface 610 of FIG. 6) can be configured to allow user navigation through the logical tree structure for construction of corresponding data selection criteria (e.g., data selection criteria 306 of FIG. 6). Exemplary user interface screens and a corresponding logical tree structure are described below with reference to FIG. 8.

Referring now to FIG. 8, a relational view of a series of user interface screens 810-840 displayed in a user interface (e.g. user interface 610 of FIG. 6) in relation to a logical tree structure 850 is shown. The series of user interface screens 810-840 illustrates an exemplary navigation through the logical tree structure 850. The navigation is performed by a user using a query building interface (e.g., user interface 610 of FIG. 6) for construction of data selection criteria (e.g., data selection criteria 306 of FIG. 6) for a corresponding abstract query (e.g., abstract query 202 of FIG. 6). Dependent on a traversed navigation path, a condition manager (e.g., condition manager 150 of FIG. 6) creates/modifies the data selection criteria on the basis of predefined modification rules (i.e., the elements/structure of the data abstraction model 350 of FIG. 3B). The predefined modification rules define actions to be performed by the condition manager in response to user selections received from the user interface.

As was noted above, the complete query logic may not be created by the condition manager until a terminal point in the navigation path of the user is reached. However, for purposes of illustration, the construction of the query logic may be described below at each step in the user's navigation.

By way of example, the logical tree structure 850 represents the data abstraction model 350 of FIG. 3B. Illustratively, the logical tree structure 850 includes a plurality of nodes 816, 818, 826, 827, 828, 836, 838, 846 and 848. Each of the nodes 816, 818, 826, 827, 828, 836 and 838 represents one of the categories 310 or one of the logical fields 308 of the data abstraction model 350. Each of the nodes 846 and 848 represents a possible value of the logical field 3085, which is represented by node 836, according to the value attribute 342.

The logical tree structure 850 may include a plurality of logical branches, each having one or more nodes. Illustratively, the logical tree structure 850 includes two logical branches. A first logical branch starts at the top level node 816 “TESTS” and continues down to the bottom level nodes 846 “VALUE=POS” and 848 “VALUE=NEG”. A second logical branch starts at the top level node 818 “PAYMENTS” and is not shown in more detail. In the illustrated example, the user navigates through the first logical branch using the user interface screens 810-840.

The navigation starts when the user initiates a query building session. It is assumed that the query building sessions is initiated from a root node of the logical tree structure 850, which is not shown in FIG. 8 for brevity. In response to the initiation of the query building session, the user interface screen 810 is displayed. The logical tree structure 850 is traversed from the root node to a first hierarchical level which is immediately below the root node. Illustratively, the first hierarchical level includes the nodes 816 “TESTS” and 818 “PAYMENTS”. Thus, the user interface screen 810 displays user-selectable elements, each representing a node of the first hierarchical level. By way of example, the user interface screen 810 displays a drop-down menu 812 having a plurality of selectable items, each corresponding to one of the nodes 816, 818. Assume now that the user wants to select the node 816 “Tests”, as indicated by dashed arrow 852. In this case, the user selects the menu item 814 “TESTS”, which is illustratively hatched as a visual confirmation of the selection.

The underlying node 816 “TESTS” represents the navigational category 3102 of the data abstraction model 350. In one embodiment, a predefined modification rule for navigational categories defines that no action is to be performed by the condition manager if a navigational category is traversed. Thus, the navigation continues in response to selection of the menu item 814 “TESTS” to a second hierarchical level of the logical tree structure 850 which is immediately below the first hierarchical level. Illustratively, the second hierarchical level includes the nodes 826 “BOTH”, 827 “FEMALES” and 828 “MALES” which correspond to the conditional categories 3105, 3103 and 3104 of the data abstraction model 350, respectively.

For each node of the second hierarchical level, an associated user-selectable element is displayed in the user interface screen 820. Illustratively, the user interface screen 820 displays a drop-down menu 822 having a plurality of selectable items, each corresponding to one of the nodes 826, 827 and 828. Assume now that the user wants to select the node 828 “MALES”, as indicated by dashed arrow 854. Therefore, the user selects the menu item 824 “MALES” from the drop-down menu 822, which is illustratively hatched as a visual confirmation of the selection.

The underlying node 828 “MALES” represents the conditional category 310₄ of the data abstraction model 350 which is associated with category condition 340₂. In one embodiment, a predefined modification rule for conditional categories causes the condition manager to retrieve an associated category condition if a conditional category is traversed in the logical tree structure 850. The predefined modification rule further causes the condition manager to identify a query condition from the retrieved category condition, which is then included with the data selection criteria of the corresponding abstract query. In the given example, the condition manager retrieves the category condition 340₂ (line 008 in Table III) from the data abstraction model 350 and includes a first query condition “Gender=Male” with the data selection criteria.

The navigation then continues to a third hierarchical level of the logical tree structure 850 which is immediately below the second hierarchical level. Illustratively, the third hierarchical level includes the nodes 836 “PROSTATE CANCER SCREENING” and 838 “SCHOLEOSIS SCREENING” which correspond to the logical fields 308₅ and 308₆ of the data abstraction model 350, respectively.

For each node of the third hierarchical level, an associated user-selectable element is displayed in the user interface screen 830. Illustratively, the user interface screen 830 displays a drop-down menu 832 having a plurality of selectable items, each corresponding to one of the nodes 836 and 838. Assume now that the user wants to select the node 836 “PROSTATE CANCER SCREENING”, as indicated by dashed arrow 856. In this case, the user selects the menu item 834 “PCS” from the drop-down menu 832, which is illustratively hatched as a visual confirmation of the selection.

The underlying node 836 “PROSTATE CANCER SCREENING” represents the logical field 308₅ of the data abstraction model 350. In one embodiment, a predefined modification rule for logical fields causes the condition manager to determine whether the logical field includes a condition modifier. If the logical field has a condition modifier, the predefined modification rule causes the condition manager to apply the condition modifier to the data selection criteria. In the given example, the logical field 308₅ does not contain a condition modifier.

The navigation thus continues to a fourth hierarchical level of the logical tree structure 850 which is immediately below the third hierarchical level. Illustratively, the fourth hierarchical level includes the nodes 846 “VALUE=POS” and 848 “VALUE=NEG” which are defined by the values of the value attribute 342.

For each node of the fourth hierarchical level, an associated user-selectable element is displayed in the user interface screen 840. Illustratively, the user interface screen 840 displays a drop-down menu 842 having a plurality of selectable items, each corresponding to one of the nodes 846 and 848. Assume now that the user wants to select the node 846 “VALUE=POS”, as indicated by dashed arrow 858. In this case, the user selects the menu item 843 “POS” from the drop-down menu 842, which is illustratively hatched as a visual confirmation of the selection.

In response to the user selection of the menu item 843, the condition manager constructs a second query condition “Prostate Cancer Screening=Pos” and adds this second query condition to the data selection criteria using a Boolean AND operator. Thus, the data selection criteria is defined by the first and second query conditions as illustrated in Table VI below.

TABLE VI
DATA SELECTION CRITERIA EXAMPLE

| | |
|---|---|
| 001 | Gender = Male |
| 002 | AND |
| 003 | Prostate Cancer Screening = Pos |

Note that the first query condition is illustrated in line 001 of Table VI and that the second query condition is illustrated in line 003. Both query conditions are connected by the Boolean AND operator (line 002).

Since, in the illustrated user interface screen 840, a specific value is selected for the logical field 308₅ for construction of a corresponding query condition, a predefined modification rule causes the condition manager to determine whether the first and the second query conditions satisfy a predefined modification criterion. More specifically, the condition manager determines whether the first query condition includes a particular value and whether the second query condition is built on a particular logical field. If the modification criterion is satisfied, the condition manager determines whether the logical field 308₅ includes a condition adapter. If the logical field includes a condition adapter, the predefined modification rule causes the condition manager to apply the condition adapter to the data selection criteria. In the given example, as the first query condition has a value “Male”, the modification criterion is only satisfied if the second query condition is built on the logical field “Prostate Cancer Screening”. As the second query condition is built on the logical field “Prostate Cancer Screening”, the condition manager retrieves the condition adapter 344 (lines 014-019 in Table III) from the logical field 308₅. Then, the condition manager retrieves the adapter condition “Age>30” and the Boolean operator AND from the condition adapter 344 and adds the adapter condition to the data selection criteria. Thus, the data selection criteria are modified to resulting data selection criteria as illustrated in Table VII below.

TABLE VII
RESULTING DATA SELECTION CRITERIA EXAMPLE

| | |
|---|---|
| 001 | Gender = Male AND Age > 30 |
| 002 | AND |
| 003 | Prostate Cancer Screening = Pos |

Note that according to line 001 the first query condition of line 001 in Table VI has been modified by adding the adapter condition thereto. According to the modified first query condition, only information relating to individuals of the gender “Male” who are older than 30 years is retrieved. However, in the given example the adapter condition may alternatively be added at the end of the data selection criteria, as the first and second query conditions are connected via a Boolean AND operator.

Once the user has made all the desired selections, the user may click on a pushbutton 844 “APPLY” to include the created data selection criteria with the corresponding abstract query. After pushing the pushbutton 844, the user may add additional logic to the query by traversing a different logical branch of the logical tree structure 850, or may run the query.

In one embodiment, the user interface screen 840 displays a summarizing display section which shows the data selection criteria which are created on the basis of the user navigation through the logical tree structure 850 using the user interface screens 810-840. More specifically, the summarizing display section can display the resulting data selection criteria as illustrated in Table VII above. Thus, the user may review the created data selection criteria before clicking the pushbutton 844, and revise the created data selection criteria if required.

In the illustrated example, the dashed arrows 852, 854, 856 and 858 illustrate the navigation path corresponding to the user selections which are performed using the user interface screens 810-840. On the basis of the user selections and the traversed navigation path, the data selection criteria of the corresponding abstract query are created and/or modified.

In various embodiments, the invention provides numerous advantages over the prior art. More specifically, providing conditional categories in a data abstraction model according to embodiments of the invention reduces errors in query building processes. For example, while a hemoglobin test can be valid for both gender, i.e., “Males” and “Females”, many medical tests are gender-specific. However, according to embodiments of the invention “Male”-specific tests are not included in a conditional category for “Females” and vice versa. Thus, when navigating through the conditional category “Females”, no “Male”-specific tests can be selected while trying to accomplish a different task. Accordingly, invalid queries having as data selection criteria, for example, “Gender=Male” AND “Pregnancy test=positive” can not be created accidentally.

Furthermore, the knowledge of the hierarchical structure of an underlying data abstraction model that the users require for creating data selection criteria is reduced. For instance, in the data abstraction model of FIG. 3A, there are two different categories sharing the information required by the user: “Patient” and “Tests”. The user must navigate through the “Patient” category to construct the query condition “Gender=Male”. Then, the user needs to navigate through the “Tests” category to construct the query condition “Prostate Cancer Screening=Pos”. In contrast, according to embodiments of the invention only a single conditional category needs to be traversed, i.e., the conditional category “Males” of the data abstraction model in FIG. 3B.

It should be noted that any reference herein to particular values, definitions, programming languages and examples is merely for purposes of illustration. Accordingly, the invention is not limited by any particular illustrations and examples. Furthermore, while the foregoing is directed to embodiments of the present invention, other and further embodiments of the invention may be devised without departing from the basic scope thereof, and the scope thereof is determined by the claims that follow.

What is claimed is:

1. A computer-implemented method of composing a query against data in a database, comprising:
receiving user input for constructing a first query condition of the query;
identifying user-selectable elements to display for constructing a second query condition of the query, wherein which user-selectable elements are identified is dependent on the first query condition;
displaying the identified user-selectable elements for constructing the second query condition;
receiving user selection of one or more of the displayed user-selectable elements for constructing the second query condition, wherein the first and second query conditions define selection criteria for selection of a specific set of the data from the database; and
programmatically modifying the selection criteria in response to construction of the second query condition on the basis of one or more predefined modification rules, whereby the specific set of the data is altered.

2. The method of claim 1, wherein identifying the user-selectable elements to display for constructing the second query condition comprises:
accessing a predefined navigation structure defining a plurality of navigation branches, each branch specifying which of a plurality of user-selectable elements to display.

3. The method of claim 2, wherein the navigation structure further defines query logic to be added to query.

4. The method of claim 2, wherein the navigation structure ensures that only valid queries can be built.

5. The method of claim 1, wherein programmatically modifying the selection criteria comprises:
restricting the selection criteria to reduce the specific set of the data.

6. The method of claim 1, wherein programmatically modifying the selection criteria comprises:
adding a third query condition to the selection criteria.

7. The method of claim 1, wherein programmatically modifying the selection criteria comprises:
changing the first query condition based on the second query condition.

8. The method of claim 7, further comprising:
determining whether the first and second query conditions satisfy a predefined modification criterion; and
wherein programmatically modifying the selection criteria is only performed if the predefined modification criterion is satisfied.

9. The method of claim 8, wherein the first query condition is associated with a first value and the second query condition is associated with a second value; and wherein the predefined modification criterion is satisfied if each of the first and second values corresponds to an associated predetermined value.

10. The method of claim 1, further comprising:
receiving user input for constructing a result field specification of the query, the result field specification including one or more result fields;
executing the query against the data in the database to determine the altered specific set of the data;
identifying, for each result field of the result field specification, result data from the altered specific set of the data on the basis of the modified selection criteria; and
returning the identified result data to the user.

11. A computer-implemented method of composing an abstract query against data in a database on the basis of a data abstraction model abstractly describing the data in the database, comprising:
displaying first user-selectable elements for constructing a first query condition of the abstract query, each user-selectable element being displayed for a different node of a logical tree structure hierarchically representing the data abstraction model;
receiving user selection of one or more of the first user-selectable elements for constructing the first query condition;
identifying nodes from the logical tree structure for constructing a second query condition of the abstract query, wherein which nodes are identified is dependent on the first query condition;
displaying second user-selectable elements for the identified nodes for constructing the second query condition of the abstract query;
receiving user selection of one or more of the second user-selectable elements for constructing the second query condition, wherein the first and second query conditions define selection criteria for selection of a specific set of the data from the database; and
programmatically modifying the selection criteria in response to construction of the second query condition on the basis of one or more predefined modification rules, whereby the specific set of the data is altered.

12. The method of claim 11, wherein the data abstraction model defines:
a multiplicity of logical fields, each being mapped to one or more physical entities of the data in the database; and
one or more category specifications, each defining one of a navigational and a conditional category, wherein:
each navigational category defines a category for logically grouping logical fields on the basis of user-defined grouping criteria; and
each conditional category defines a category for logically grouping logical fields on the basis of a category condition defining at least one query
condition to be applied to the abstract query on the basis of the one or more predefined modification rules.

13. The method of claim 12, wherein the data abstraction model is adapted for transforming logical fields of abstract queries into a form consistent with a physical representation of the data in the database.

14. The method of claim 12, wherein the logical tree structure comprises a plurality of nodes, each node representing one of:
(i) a logical field;
(ii) a navigational category; and
(iii) a conditional category.

15. The method of claim 14, wherein at least one of the first and the second query condition is programmatically constructed on the basis of a given category condition.

16. The method of claim 14, wherein at least one of the one or more selected first user-selectable elements represents a conditional category having an associated category condition; and
wherein constructing the first query condition comprises:
programmatically constructing the first query condition on the basis of the associated category condition.

17. The method of claim 16, wherein at least one of the one or more selected second user-selectable elements represents a logical field having an associated adapter condition defining a modification to be performed on the selection criteria, the method further comprising:
receiving user input specifying a comparison operator and a value for the second query condition; and
wherein constructing the second query condition comprises:
generating the second query condition on the basis of the represented logical field, the specified comparison operator and the specified value.

18. The method of claim 17, wherein programmatically modifying the selection criteria is performed on the basis of the associated adapter condition.

19. The method of claim 18, wherein programmatically modifying the selection criteria on the basis of the associated adapter condition comprises:
restricting the selection criteria on the basis of the associated adapter condition to reduce the specific set of the data.

20. The method of claim 18, wherein programmatically modifying the selection criteria on the basis of the associated adapter condition comprises:
adding a third query condition to the selection criteria on the basis of the associated adapter condition.

21. The method of claim 16, wherein at least one of the one or more selected second user-selectable elements represents a logical field having an associated modifier condition defining a change to be performed on the selection criteria; and
wherein programmatically modifying the selection criteria is performed on the basis of the associated modifier condition.

22. The method of claim 21, wherein programmatically modifying the selection criteria on the basis of the associated modifier condition comprises:
changing the first query condition based on the associated modifier condition.

23. The method of claim 11, further comprising:
constructing a result field specification of the abstract query based on user input, the result field specification including one or more result fields each corresponding to a logical field of the data abstraction model;
transforming the abstract query on the basis of the data abstraction model into a concrete query consistent with a physical representation of the data in the database;
executing the concrete query against the data in the database to determine the altered specific set of the data;
identifying, for each result field of the result field specification, result data from the altered specific set of the data on the basis of the modified selection criteria; and
returning the identified result data to the user.

24. A computer-implemented method of constructing queries, comprising:
displaying a first graphical user interface screen containing user-selectable query-building elements for constructing a first query condition of a query;
receiving user selections of the user-selectable query-building elements to construct the first query condition;
after constructing the first query condition, displaying one or more additional graphical user interface screens each containing user-selectable query-building elements for constructing another query condition of the query, wherein the user-selectable query-building elements of each additional graphical user interface screen are determined by accessing a navigation tree defining which user-selectable query-building elements will be displayed on the basis of a user's previous selections of user-selectable query-building elements for the query; and
after construction of one or more given query conditions, programmatically modifying the query in response to construction of the given query condition on the basis of one or more predefined modification rules.

25. A computer-readable medium containing a program which, when executed by a processor, performs operations for composing a query against data in a database, the operations comprising:
receiving user input for constructing a first query condition of the query;
identifying user-selectable elements to display for constructing a second query condition of the query, wherein which user-selectable elements are identified is dependent on the first query condition;
displaying the identified user-selectable elements for constructing the second query condition;
receiving user selection of one or more of the displayed user-selectable elements for constructing the second query condition, wherein the first and second query conditions define selection criteria for selection of a specific set of the data from the database; and
programmatically modifying the selection criteria in response to construction of the second query condition on the basis of one or more predefined modification rules, whereby the specific set of the data is altered.

26. The computer-readable medium of claim 25, wherein identifying the user-selectable elements to display for constructing the second query condition comprises:
accessing a navigation structure defining a plurality of navigation branches, each branch specifying which of a plurality of user-selectable elements to display.

27. The computer-readable medium of claim 26, wherein the navigation structure further defines query logic to be added to query.

28. The computer-readable medium of claim 26, wherein the navigation structure ensures that only valid queries can be built.

29. The computer-readable medium of claim 25, wherein programmatically modifying the selection criteria comprises:
restricting the selection criteria to reduce the specific set of the data.

30. The computer-readable medium of claim 25, wherein programmatically modifying the selection criteria comprises:
adding a third query condition to the selection criteria.

31. The computer-readable medium of claim 25, wherein programmatically modifying the selection criteria comprises:
changing the first query condition based on the second query condition.

32. The computer-readable medium of claim 31, wherein the operations further comprise:
determining whether the first and second query conditions satisfy a predefined modification criterion; and
wherein programmatically modifying the selection criteria is only performed if the predefined modification criterion is satisfied.

33. The computer-readable medium of claim 32, wherein the first query condition is associated with a first value and the second query condition is associated with a second value; and wherein the predefined modification criterion is satisfied if each of the first and second values corresponds to an associated predetermined value.

34. The computer-readable medium of claim 25, wherein the operations further comprise:
receiving user input for constructing a result field specification of the query, the result field specification including one or more result fields;
executing the query against the data in the database to determine the altered specific set of the data;
identifying, for each result field of the result field specification, result data from the altered specific set of the data on the basis of the modified selection criteria; and
returning the identified result data to the user.

35. A computer-readable medium containing a program which, when executed by a processor, performs operations for composing an abstract query against data in a database on the basis of a data abstraction model abstractly describing the data in the database, the operations comprising:
displaying first user-selectable elements for constructing a first query condition of the abstract query, each user-selectable element being displayed for a different node of a logical tree structure hierarchically representing the data abstraction model;
receiving user selection of one or more of the first user-selectable elements for constructing the first query condition;
identifying nodes from the logical tree structure for constructing a second query condition of the abstract query, wherein which nodes are identified is dependent on the first query condition;
displaying second user-selectable elements for the identified nodes for constructing the second query condition of the abstract query;
receiving user selection of one or more of the second user-selectable elements for constructing the second query condition, wherein the first and second query conditions define selection criteria for selection of a specific set of the data from the database; and
programmatically modifying the selection criteria in response to construction of the second query condition on the basis of one or more predefined modification rules, whereby the specific set of the data is altered.

36. The computer-readable medium of claim 35, wherein the data abstraction model defines:
a multiplicity of logical fields, each being mapped to one or more physical entities of the data in the database; and
one or more category specifications, each defining one of a navigational and a conditional category, wherein:
each navigational category defines a category for logically grouping logical fields on the basis of user-defined grouping criteria; and
each conditional category defines a category for logically grouping logical fields on the basis of a category condition defining at least one query condition to be applied to the abstract query on the basis of the one or more predefined modification rules.

37. The computer-readable medium of claim 36, wherein the data abstraction model is adapted for transforming logical fields of abstract queries into a form consistent with a physical representation of the data in the database.

38. The computer-readable medium of claim 36, wherein the logical tree structure comprises a plurality of nodes, each node representing one of:
(i) a logical field;
(ii) a navigational category; and
(iii) a conditional category.

39. The computer-readable medium of claim 38, wherein at least one of the first and the second query condition is programmatically constructed on the basis of a given category condition.

40. The computer-readable medium of claim 38, wherein at least one of the one or more selected first user-selectable elements represents a conditional category having an associated category condition; and
wherein constructing the first query condition comprises:
programmatically constructing the first query condition on the basis of the associated category condition.

41. The computer-readable medium of claim 40, wherein at least one of the one or more selected second user-selectable elements represents a logical field having an associated adapter condition defining a modification to be performed on the selection criteria, the operations further comprising:
receiving user input specifying a comparison operator and a value for the second query condition; and
wherein constructing the second query condition comprises:
generating the second query condition on the basis of the represented logical field, the specified comparison operator and the specified value.

42. The computer-readable medium of claim 41, wherein programmatically modifying the selection criteria is performed on the basis of the associated adapter condition.

43. The computer-readable medium of claim 42, wherein programmatically modifying the selection criteria on the basis of the associated adapter condition comprises:
restricting the selection criteria on the basis of the associated adapter condition to reduce the specific set of the data.

44. The computer-readable medium of claim 42, wherein programmatically modifying the selection criteria on the basis of the associated adapter condition comprises:
adding a third query condition to the selection criteria on the basis of the associated adapter condition.

45. The computer-readable medium of claim 40, wherein at least one of the one or more selected second user-selectable elements represents a logical field having an associated modifier condition defining a change to be performed on the selection criteria; and
wherein programmatically modifying the selection criteria is performed on the basis of the associated modifier condition.

46. The computer-readable medium of claim 45, wherein programmatically modifying the selection criteria on the basis of the associated modifier condition comprises:
changing the first query condition based on the associated modifier condition.

47. The computer-readable medium of claim 35, wherein the operations further comprise:
constructing a result field specification of the abstract query based on user input, the result field specification including one or more result fields each corresponding to a logical field of the data abstraction model;
transforming the abstract query on the basis of the data abstraction model into a concrete query consistent with a physical representation of the data in the database;
executing the concrete query against the data in the database to determine the altered specific set of the data;
identifying, for each result field of the result field specification, result data from the altered specific set of the data on the basis of the modified selection criteria; and
returning the identified result data to the user.

48. A computer-readable medium containing a program which, when executed by a processor, performs operations for constructing queries, the operations comprising:
displaying a first graphical user interface screen containing user-selectable query-building elements for constructing a first query condition of a query;
receiving user selections of the user-selectable query-building elements to construct the first query condition;
after constructing the first query condition, displaying one or more additional graphical user interface screens each containing user-selectable query-building elements for constructing another query condition of the query, wherein the user-selectable query-building elements of each additional graphical user interface screen are determined by accessing a navigation tree defining which user-selectable query-building elements will be displayed on the basis of a user's previous selections of user-selectable query-building elements for the query; and
after construction of one or more given query conditions, programmatically modifying the query in response to construction of the given query condition on the basis of one or more predefined modification rules.

49. A system, comprising:
a display device;
a navigation structure defining predefined navigation paths for users;
one or more modification rules for defining application of modifications to a query condition on the basis of another query condition;
a user interface for composing a query against data in a database; and
a condition manager configured to:
receive user input for constructing a first query condition of the query from the user interface;
access the navigation structure to identify user-selectable elements to display for constructing a second query condition of the query, wherein each navigation path specifies which of a plurality of user-selectable elements to display dependent on the first query condition;
display the identified user-selectable elements for constructing the second query condition on the display device;
receive user selection of one or more of the displayed user-selectable elements for constructing the second query condition from the user interface, wherein the first and second query conditions define selection criteria for selection of a specific set of the data from the database; and
programmatically modify the selection criteria in response to construction of the second query condition on the basis of one or more corresponding modification rules, whereby the specific set of the data is altered.
